(19) United States
(12) Patent Application Publication
(10) Pub. No.: US 2022/0247578 A1
(43) Pub. Date: Aug. 4, 2022

(54) ATTESTATION OF DEVICE MANAGEMENT WITHIN AUTHENTICATION FLOW

(71) Applicant: Okta, Inc., San Francisco, CA (US)

(72) Inventors: Manish Agarwal, Sammamish, WA (US); Mohammad Rahimi, Sunnyvale, CA (US)

(21) Appl. No.: 17/163,070

(22) Filed: Jan. 29, 2021

(51) Int. Cl. H04L 9/32; H04L 9/08

(52) U.S. Cl. CPC H04L 9/3268; H04L 9/0825; H04L 2209/80; H04L 9/3213; H04L 9/083; H04L 9/3271

(57) ABSTRACT

An organization uses an independent separate authentication system to authenticate users or the organization for access to resources of the organization. The organization also uses an MDM system independent both of the organization and of the authentication system to administer the client devices of the organization's users and to ensure that the client devices handle the resources of the organization in a secure manner. In order to allow the authentication system to consider MDM management status of a client device when authenticating a user, the authentication system and the organization cooperate to establish a mechanism whereby the authentication system can securely determine whether a particular client device requesting access to an organization resource is in fact managed by an MDM system.

### FIELD OF ART

The present invention generally relates to the field of software systems, and more specifically, to facilitating user authentication for access to applications or other digital resources provided by a number of different entities.

### BACKGROUND

Organizations (such as businesses, government departments, or the like) have many users, each of whom typically has multiple accounts with different independent systems, such as various third-party applications and/or websites, with different credentials (e.g., username and password or other factors) for each. The need of users to authenticate their identities separately for each of their separate accounts in order to access their resources on those accounts requires significant effort and reduces the productivity of those users due to the need to remember authentication credentials and enter those credentials for each of their accounts. This difficulty may further lead to security risks if users attempt to mitigate the difficulty through ill-advised practices such as password reuse, listing passwords in insecure locations, or the like.

Such users could benefit greatly from the ability to use federated identities linking their identities across their various accounts, and from applications thereof such as single sign-on (SSO) to automatically log them into their different accounts. However, providing federated identities in a secure manner is a technically complex problem beyond the capabilities of most organizations. To address these difficulties, organizations may entrust a separate authentication system with user credentials for authenticating their users on their various third-party accounts on different systems, and the authentication system may facilitate the authentication of the user across the various accounts and systems using those credentials.

Even with an authentication system, an organization may additionally wish for the client computing devices used by the users to have added layers of security to reduce the risk of organization resources being compromised through the access of the users. Mobile device management (MDM) is one type of additional security layer. MDM software installed on user client devices enables operations such as client device tracking, monitoring, configuration, and the like, all of which cause the client devices to be more secure. Thus, it is desirable to incorporate additional security layers such as MDM within the same flow of control already performed by the authentication system. However, the authentication system and the MDM provider are often separate and independent systems, such that the authentication system cannot directly verify the MDM status of client devices during the authentication flow.

### SUMMARY

An organization uses an independent authentication system to authenticate users of the organization for access to resources of the organization. The organization also uses an MDM system independent both of the organization and of the authentication system to administer the client devices of the organization's users and to ensure that the client devices handle the resources of the organization in a secure manner. In order to allow the authentication system to evaluate MDM management status of a client device when authenticating a user, the authentication system and the organization cooperate to establish a mechanism whereby the authentication system can securely determine whether a particular client device requesting access to an organization resource is in fact managed by an MDM system.

To establish the aforementioned mechanism, the organization defines an MDM policy that causes the client devices to request local client digital certificates that establish that the client devices are being managed by an MDM system. The organization additionally provides a digital certificate of the certification authority that issued the client digital certificates (e.g., the organization itself) to the authentication system for storage. When a client device later requests access, the authentication system replies with a challenge that the client device signs with its client digital certificate to establish that it is being managed by an MDM system. The authentication system can verify the authenticity of the client digital certificate using the certificate of the certificate issuer, thereby establishing that the client device is being managed by MDM. Accordingly, the authentication system grants the access request by generating a token that indicates that the client device is managed, and the client device can provide the token to the source of the organization resource (such as a third-party application) to obtain access.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 illustrates one embodiment of a computing environment in which users use a client device to access resources of an organization.

FIG. 2 illustrates the sequence of actions performed by the entities of FIG. 1 when establishing the use of MDM attestation and when verifying that MDM attestation in response to requests of client devices for access to applications or other resources of an organization, according to some embodiments.

FIG. 3 is a high-level block diagram illustrating physical components of a computer used as part or all of (for example) the authentication system, the client device, and/or the third-party application server, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

The system of a user organization communicates with an authentication system to handle authentication of its users when gaining access to resources, such as web-based software applications on which the users have accounts. The organization additionally uses a mobile device management (MDM) system to ensure that the client computing devices (hereinafter “client devices”) of its users are secure. In order to allow integration of MDM determinations into the workflow of the authentication system, the organization and the authentication system are supplemented with components that communicate to allow verification that the client devices making requests for organization resources are indeed being managed by an MDM solution. Accordingly, the authentication system is able to incorporate MDM status as a factor in its authentication determinations.

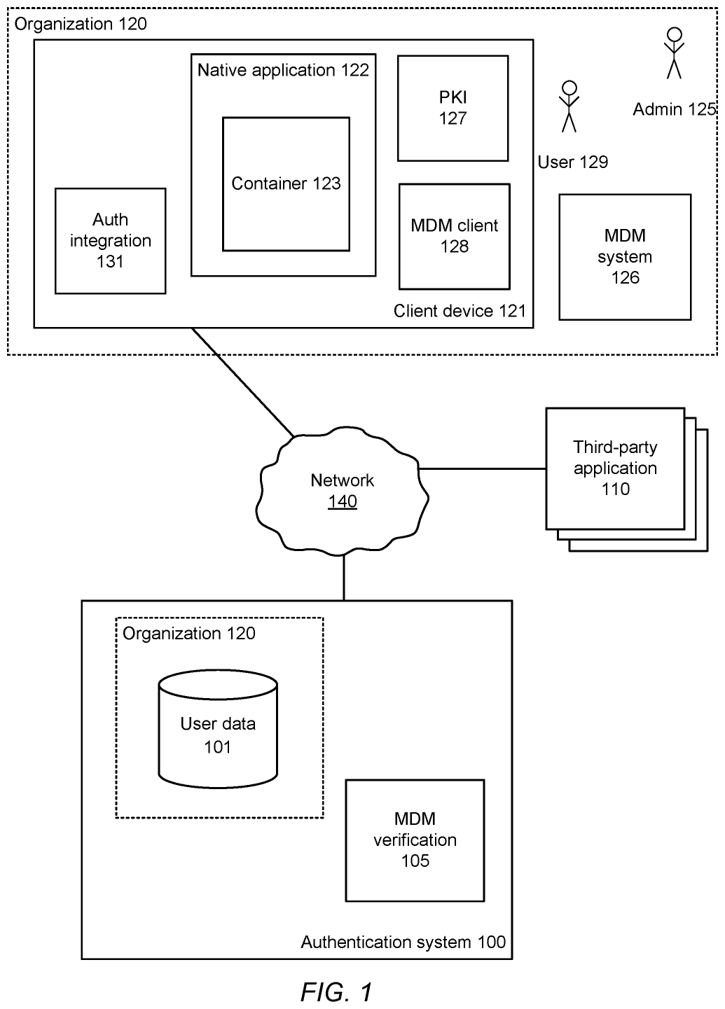

FIG. 1 illustrates one embodiment of a computing environment in which users 129 use a client device 121 to access resources of an organization 120. The users 129 are affiliated with the organization (e.g., are employees or volunteers of the organization) and may accomplish the tasks on behalf of the organization. The users 129 may have multiple accounts on different systems, and the systems may be owned and/or administered by different independent entities, such that the users may have a number of different identities—and corresponding credentials—across the different systems. The different accounts may provide the users with access to different resources, such as (for example) applications (e.g., email applications, timekeeping applications, spreadsheet applications, etc.), databases, files systems, or the like. Such applications 110 could be, for example, entirely web-based and accessible through a web browser, or could be accessible through a native application 122 installed on the user's client device and communicating with a remote application server. Since each application or other resource could be from a different provider—each of which could have a different identity for a user—a single user will typically have many different identities and associated credentials corresponding to the different resources that the user uses. FIG. 1 illustrates one such possible resource: a third-party application 110 partially or entirely implemented via an application server. An authentication system 100 provides users with a federated identity integrating the users' different identities on different accounts, thereby providing more convenient, efficient, and secure access to the different accounts. These entities are now described in more detail.

The organization 120 is an entity, such as a business, a school, a governmental agency, or the like, that has a number of affiliated users 129, such as employees or volunteers. The organization also has or integrates with one or more client devices 121 that the users 129 use to perform tasks on behalf of the organization. In other embodiments, the users are not affiliated with an organization, but instead act independently using client devices 121 belonging to them.

The authentication system 100 provides the user 129 with a federated identity linking the various identities of the user on the different accounts (e.g., the third-party applications 110) or other resources to which the user has access. The authentication system 100 stores user data 101 that include a set of identities of known users with accounts on the authentication system 100. The user data 101 may include a form of identity on the authentication system 100 such as a username, as well as other credential data associated with a user, such as a user password or information derived therefrom. The user data 101 may also include many other types of data about users, such as the factor types and providers that they may use when seeking identity verification from the Authentication system 100, their role(s) or group(s) within the organization 120 to which they belong (e.g., “Engineering”, “Legal”, “Manager 2”, “Director”, or the like), and/or the resources to which they have access (e.g., third-party applications 110 such as SALESFORCE, MICROSOFT OFFICE 365, SLACK, or the like), as some examples. The user data 101 may also include identities and credentials of the various users on the various accounts to which they have access, thereby linking a user's identity on the authentication system 100 to the user's identities on those different accounts and (by extension) permitting access to those accounts. In some embodiments, the authentication system 100 is part of the organization 120, rather than being an independent entity as it is in other embodiments.

Software on the client device 121 facilitates providing users with federated identities by securely and transparently communicating with the authentication system 100 that handles the details of identity federation and provides related identity services. In this way, the users of the organization 120 simply and securely obtain access to the various third-party accounts or other resources that they need to complete tasks on behalf of the organization. The software on the client device 121 that communicates with the authentication system 100 may (although need not) be provided by the entity responsible for the authentication system.

In some embodiments, the authentication system 100 includes single sign-on (SSO) functionality that allows the authentication system to transparently log a user in to the different accounts or other resources to which the user has access. For example, for a given user who has logged in to the authentication system 100, the authentication system can look up the user's accounts or other resources within the user data 101, as well as the user's credentials for those accounts. Using the credentials, as well as metadata or other information about the accounts, authentication system 100 can automatically log the user into the applications or other resources described in the user data 101, such as by establishing application sessions with the various applications and providing corresponding session data (e.g., session tokens) to the device 121. Thus, with a single login to the authentication system 100, the SSO functionality of the authentication system provides a user with automatic access to all the user's accounts or other resources.

In some embodiments, a client device 121 includes a number of components that a user 129 can use to accomplish tasks via applications or other resources, or that interface with the authentication system 100 in order to provide federated identities, SSO functionality, and/or other functionality. These components are now described in more detail.

The client device 121 may include a native application 122, which is a locally-installed application that communicates with a third-party application server 110 to provide application functionality, such as an email application, a chat application, an accounting application, or the like. For example, the native application 122 may provide the user interface for the application and communicate with its corresponding third-party application server 110 to access the user's data to display within the user interface. Alternatively, a given application may not be installed locally on the client device 121, but rather may be downloaded and executed entirely within a web browser on the client device 121, for example. (The terms “application 110”, “application 122”, or simply “application” are sometimes used interchangeably herein to general denote functionality of the application, whether it is implemented entirely on the application server 110, or partially on the application server 110 and partially via the native application 122.)

An application executing on the client device 121 (whether the application is a native application 122 or a fully web-based application) can include a container 123 that hosts code provided to it. For example, in one embodiment the container 123 is implemented as an embeddable browser, such as a WebView that runs scripting code (e.g., JavaScript™ code) within a native application 122. For example, in some embodiments the container 123 obtains a sign-in widget, which is code that handles details of communication with the authentication system 100 on behalf of the application 122. In some embodiments, the application executing on the client device 121 makes direct calls to an API of the authentication system 100 to perform authentication.

The client device 121 further includes an authentication integration module 131 that handles communication with the authentication system 100 in order to authenticate the client device 121 and its user 129 with the authentication system 100. In some embodiments, the authentication integration module 131 is authored by the same entity responsible for the authentication system 100.

MDM Attestation

The environment additionally contains various components that together provide attestation to the authentication system 100 that a given client device 121 attempting to access an account on a third-party application 110 or other resource of the organization uses MDM. These components include an MDM system 126 of the organization 120, an MDM client module 128 and a public key infrastructure (PKI) module 127 on the client device 121, and an MDM verification module 105 on the authentication system 100.

The MDM system 126 of the organization 120 provides an administrator 125 of the organization 120 with the ability to manage the different client devices 121 authorized to use resources of the organization. For example, the MDM system 126 allows monitoring of the state of the client devices 121, remote installation and de-installation of software on the client devices, remote configuration of the software on the client devices (e.g., to ensure that adequate security standards are met, such as local encryption of data), copying/installation of files, remote “wipe” of client devices to remove enterprise data, endpoint protection to ensure that the client devices are up-to-date, updating the operating system, and the like. The MDM system 126 may also be provided with a system policy which the MDM system analyzes and implements by sending commands to client devices 121. For example, a policy can specify that all client devices 121 managed by the MDM system must obtain a cryptographic digital certificate signed by the organization 120 and attesting that the client device is being managed by the MDM system 126.

The MDM client software 128 on the client devices 121 interacts with the MDM system 126, responding to commands that the MDM system issues to verify or maintain security of the organization resources. For example, the MDM client software 128 can implement the requirement that the client device 121 have a digital certificate, when so instructed by the MDM system 126. For instance, the OMA Device Management (OMA DM) protocol may be used between the client devices 121, their MDM clients 128, and the MDM system 126, with the client devices periodically checking in with the MDM system 126, and the MDM system instructing the client devices to implement any policies not yet implemented, such as the installation of certificates. When obtaining the digital certificate, the MDM client 128 uses a local PKI module 127 to generate a <public, private> keypair. The MDM client 128 then provides the generated public key to a certificate granting module of the organization, which certifies that the identity of the client device 121 corresponds to the generated public key by generating a certificate containing the public key and an identifier of the client device, and signing the certificate using the organization's own private key.

The authentication system 100 includes an MDM verification module 105 that the authentication system can use when determining whether a particular client device 121 making a request for resources of an organization 120 is being managed by MDM. For example, in one embodiment organizations 120 may specify to the authentication system 100 (e.g., via policy settings) whether they wish device MDM management status to be a signal used in making authentication determinations. If a given organization 120 specifies that they do wish MDM management status to be analyzed in authentication determinations, then the authentication system 100 uses the MDM verification module 105 to assess this. Specifically, the MDM verification module 105 obtains the data sent by a client device 121 as part of its request for authentication and determines whether the data is signed by a digital certificate. If the data is in fact signed, then the MDM verification module 105 further verifies the digital certificate used for signing by checking the signature on the certificate to ensure that it was signed by the organization 120 issuing the certificate (which is the entity that has knowledge of whether MDM is being applied to a given client device).

Physically, the organization 120 is made up of a number of computing systems, including the various client devices 121; one or more internal networks that connects the computing systems, including routers or other networking devices that define the boundary between the organization and external networks; and the like.

Similarly, the authentication system 100, although depicted as a single logical system in FIG. 1, may be implemented using a number of distinct physical systems and the connections between them, such as application servers, database servers, load-balancing servers, routers, and the like.

The network 140 may be any suitable communications network for data transmission. In an embodiment such as that illustrated in FIG. 1, the network 140 uses standard communications technologies and/or protocols and can include the Internet. In another embodiment, the entities use custom and/or dedicated data communications technologies.

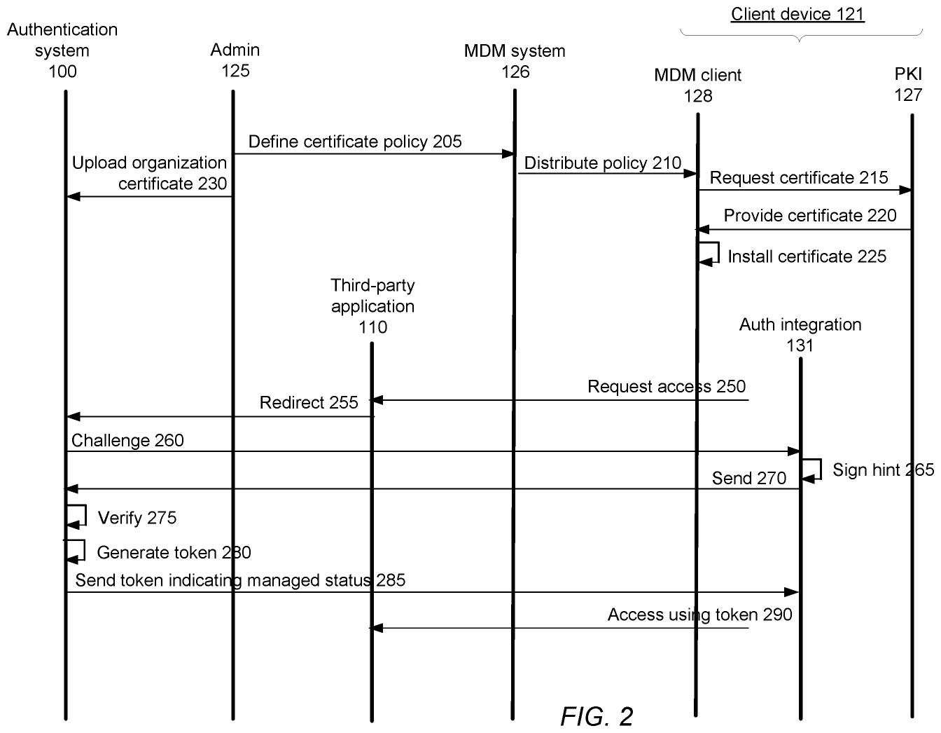

FIG. 2 illustrates the sequence of actions performed by the entities of FIG. 1 when establishing the use of MDM attestation and when verifying that MDM attestation in response to requests of client devices for access to applications 110 or other resources of an organization 120, according to some embodiments. In steps 205 to 225, the authentication system 100, organization 120, and client devices 121 are initialized to incorporate MDM attestation determinations into the authentication flow of the authentication system. In steps 250 to 290, a client device 121 makes a request for a resource (an account of a user on a third-party application 110) of the organization 120, and the authentication system 100 assesses whether to authenticate the client device, based at least in part on the MDM attestation determination.

Initialization of MDM Attestation

An administrator 125 of the organization wishing to verify MDM status as part of authentication defines 205 in its MDM policy that client devices should obtain digital certificates establishing that they are being managed by MDM. The MDM system 126 of the organization 120 accordingly distributes 210 this policy requirement to the MDM client software 128 on the client devices 121. The MDM client software 128 enacts the requirement by requesting 215 the PKI module to generate a <public, private> keypair and to obtain a signed certificate binding the generated public key to an identity of the client device. The PKI module 127 provides the public key to a certificate-issuing module of the organization 120, which generates and signs the certificate, or to another certification authority that the organization uses. The certificate is then provided 220 to the MDM client 128, which installs 225 the certificate (e.g., in secure local storage) on the client device 121. For additional security, the certificate-issuing module of the organization 120 can bind the certificate to the user and device 121 in order to ensure that the same certificate cannot be used by another user, or by the same user on different devices.

An administrator 125 of the organization 120 also uploads 230 a certificate of the certification authority of the organization to the authentication system 100. Since the organization 120 is the entity that issued the certificate at step 215, the certificate of the organization's certification authority permits the authentication system 100 to verify signatures of the client devices generated using the public key of the certificate generated and installed in steps 215-225.

Use of MDM Attestation in Authentication

At step 250, a user of a client device 121 makes a request to access an account of a user on third-party application 110, e.g., when signing on to the third-party application. The third-party application 110 examines the header of the HTTP request corresponding to the access request to determine whether a token confirming that the user is logged in is present. If the token is not present, the third-party application 110 redirects 255 the request to the authentication system 100 to determine whether the request should be granted. The authentication system 100 issues 260 a challenge to the client device 121 to verify that it is managed by MDM. The challenge includes a nonce value encrypted with the public key of the client device 121, to prevent later replay. The authentication integration module 131 of the client device 121 signs 265 a management hint attesting that the client device is indeed managed by MDM, and sends 270 the signed hint to the authentication system 100. The management hint includes a nonce signed with the private key corresponding to the client certificate obtained and installed in steps 215-225. The management hint can be implemented as (for example) a JSON Web Token (JWT).

The authentication system 100 verifies 275 the signed management hint. The verification entails determining that the certificate of the client device 121 used to sign the management hint is indeed valid; the authentication system 100 accomplishes this by using the organization certificate that was uploaded at step 230. For example, in some embodiments in which the management hint is implemented with a JWT, the authentication system 100 examines a known header (e.g., “x5c”) of the JWT to obtain the public portion of the signing certificate, and verifies that the JWT is signed with the certificate that that certificate was uploaded in step 230.

If the authentication system 100 successfully verifies the signed management hint, this establishes that the client device 121 requesting the access is indeed being managed by MDM, given that (1) the MDM system caused the installation of the client certificate, (2) the client device signed the nonce using the private key corresponding to the certificate, and (3) the administrator 125 uploaded 230 the organization certificate. Thus, the client device 121 can be trusted with access. Accordingly, the authentication system 100 generates 280 a token indicating that the client device 121 has been authenticated by the authentication system 100 to gain access and sends 285 it to the client device 121. The client device 121 accordingly accesses 290 the application 110 or other requested resource using the token, such as providing the token as part of the application's Security Assertion Markup Language (SAML) or other authentication flow.

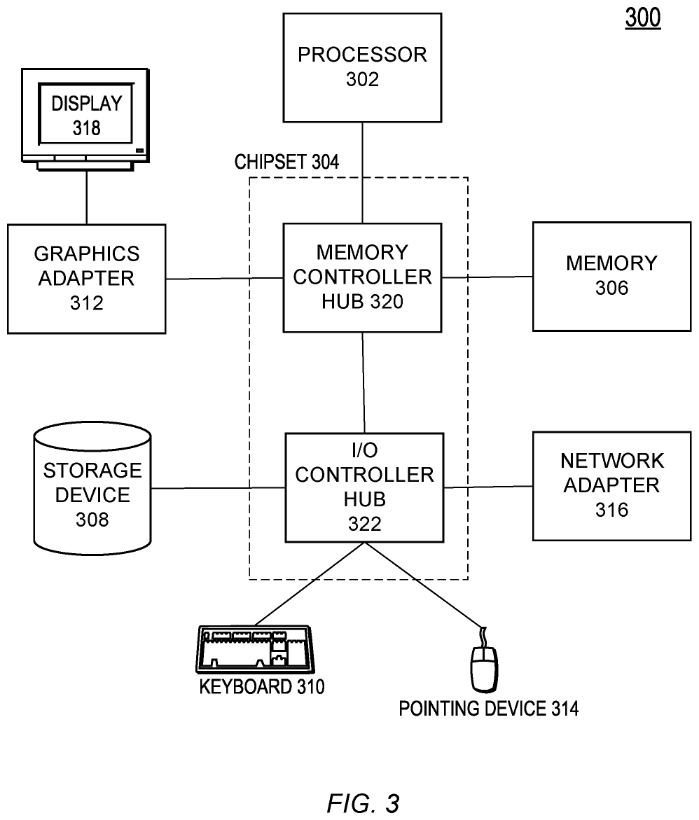

FIG. 3 is a high-level block diagram illustrating physical components of a computer 300 used as part or all of (for example) the authentication system 100, the client device 121, and/or the third-party application server 110, according to one embodiment. Illustrated are at least one processor 302 coupled to a chipset 304. Also coupled to the chipset 304 are a memory 306, a storage device 308, a graphics adapter 312, and a network adapter 316. A display 318 is coupled to the graphics adapter 312. In one embodiment, the functionality of the chipset 304 is provided by a memory controller hub 320 and an I/O controller hub 322. In another embodiment, the memory 306 is coupled directly to the processor 302 instead of the chipset 304.

The storage device 308 is any non-transitory computer-readable storage medium, such as a hard drive, compact disk read-only memory (CD-ROM), DVD, or a solid-state memory device. The memory 306 holds instructions and data used by the processor 302. The graphics adapter 312 displays images and other information on the display 318. The network adapter 316 couples the computer 300 to a local or wide area network.

As is known in the art, a computer 300 can have different and/or other components than those shown in FIG. 3. In addition, the computer 300 can lack certain illustrated components. In one embodiment, a computer 300 acting as a server may lack a graphics adapter 312, and/or display 318, as well as a keyboard 310 or pointing device 314. Moreover, the storage device 308 can be local and/or remote from the computer 300 (such as embodied within a storage area network (SAN)).

As is known in the art, the computer 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 308, loaded into the memory 306, and executed by the processor 302.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Other Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer-implemented method for integrating attestation of mobile device management (MDM) of an organization within a flow of an authentication system, the computer-implemented method comprising:
defining an MDM certificate policy for managed client devices of the organization;
responsive to the MDM certificate policy, requesting, by the managed client devices from a certification provider of the organization, client digital certificates certifying public keys of the managed client devices;
obtaining the requested client digital certificates from the certification provider;
installing, by the managed client devices, the obtained client digital certificates on local storage of the managed client devices;
providing a certificate of the certification authority to an authentication system;
sending, to the authentication system by a first managed client device in response to a user of the first managed client device requesting access to a third-party application to which the user has access via the organization, a request for access;
receiving a challenge from the authentication server in response to the request for access;
responsive to the challenge, signing a management hint attestation using a private key corresponding to the client certificate installed on the first managed client device;
providing the signed management hint attestation to the authentication system;
responsive to the authentication system verifying the signed management hint attestation using the certification authority certificate, receiving from the authentication server a token certifying that the first managed client device is managed; and
using the token to access resources of the organization.

2. A computer-implemented method for integrating attestation of mobile device management (MDM) of an organization within a flow of an authentication system, the computer-implemented method comprising:
responsive to an MDM certificate policy of the organization, requesting, by a managed client device from a certification provider of the organization, a client digital certificate;
obtaining the requested client digital certificate from the certification provider;
providing a certificate of the certification authority to an authentication system;
sending, to the authentication system by a first managed client device, a request for access to a resource of the organization;
responsive to a challenge from the authentication system, providing to the authentication system a management hint attestation signed using the client digital certificate;
receiving from the authentication server a token certifying that the first managed client device is managed; and
using the token to access the resource of the organization.

3. The computer-implemented method of claim 2, wherein the token is received responsive to the authentication system verifying the signed management hint attestation using the certification authority certificate.

4. The computer-implemented method of claim 2, wherein the resource is a third-party application, and wherein using the token to access the resource of the organization comprises providing the token to the third-party application as part of a SAML flow.

5. The computer-implemented method of claim 2, further comprising generating a public key and a corresponding private key, wherein the client digital certificate certifies that the public key corresponds to the client device.

6. The computer-implemented method of claim 2, wherein the resource of the organization is a third-party web-based application on which a user of the client device has an account through the organization.

7. A non-transitory computer-readable storage medium storing instructions for integrating attestation of mobile device management (MDM) of an organization within a flow of an authentication system, the instructions when executed by a computer processor performing actions comprising:
responsive to an MDM certificate policy of the organization, requesting, by a managed client device from a certification provider of the organization, a client digital certificate;
obtaining the requested client digital certificate from the certification provider;
providing a certificate of the certification authority to an authentication system;
sending, to the authentication system by a first managed client device, a request for access to a resource of the organization;
responsive to a challenge from the authentication system, providing to the authentication system a management hint attestation signed using the client digital certificate;
receiving from the authentication server a token certifying that the first managed client device is managed; and
using the token to access the resource of the organization.

8. The non-transitory computer-readable storage medium of claim 7, wherein the token is received responsive to the authentication system verifying the signed management hint attestation using the certification authority certificate.

9. The non-transitory computer-readable storage medium of claim 7, wherein the resource is a third-party application, and wherein using the token to access the resource of the organization comprises providing the token to the third-party application as part of a SAML flow.

10. The non-transitory computer-readable storage medium of claim 7, further comprising generating a public key and a corresponding private key, wherein the client digital certificate certifies that the public key corresponds to the client device.

11. The non-transitory computer-readable storage medium of claim 7, wherein the resource of the organization is a third-party web-based application on which a user of the client device has an account through the organization.
